(19) United States
(12) Patent Application Publication
(10) Pub. No.: US 2008/0033995 A1
(43) Pub. Date: Feb. 7, 2008

(54) Identifying events that correspond to a modified version of a process

(76) Inventors: Fabio Casati, Mento Park, CA (US); Maria Guadalupe Castellanos, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/497,654

(22) Filed: Aug. 2, 2006

(51) Int. Cl. G06F 7/00

(52) U.S. Cl. 707/104.1

(57) ABSTRACT

Events are received from at least one source. An abstract definition of a process provides a modified version of the process. In accordance with mapping information, events from the received events corresponding to the modified version of the process are identified. Data relating to execution of the process is stored into a repository, wherein the stored data is produced from the identified events.

### BACKGROUND

Businesses are increasingly implementing automation of various business processes (e.g., invoicing, shipping goods, paying bills, approving expenses or purchases, etc.). Automation of business processes can be performed with computers, although other types of systems may be involved in the automation. As an example, a business process can be performed by a workflow engine, which is a software application for executing the business process.

To enable improvement of efficiencies of business processes, logging techniques are implemented to log information associated with activities of the business processes. For an automated business process, such as one implemented with a workflow engine, logs are automatically generated, with such logs typically transferred to a data warehouse (which is a collection of one or more databases). However, since only a fraction of business processes are executed by workflow engines, logs for many business processes not implemented with workflow engines are usually unavailable. Incomplete information may prevent a comprehensive analysis or understanding of execution of business processes. Also, logs produced by workflow engines are typically quite detailed and complex (since the business process itself is detailed and complex), which makes such logs difficult to analyze. Thus, an effective mechanism for providing reports of activities associated with business processes is conventionally not available.

### BRIEF DESCRIPTION OF THE DRAWINGS

Some embodiments of the invention are described with respect to the following figures:

FIG. 1 is a block diagram of an arrangement that includes an extract, transformation, and load (ETL) tool according to an embodiment;

FIG. 2 illustrates an example business process for which events can be logged by the ETL tool according to some embodiments;

FIG. 3 is a flow diagram of a procedure performed by the ETL tool according to an embodiment; and

FIG. 4 illustrates output tables produced by the ETL tool according to an embodiment.

### DETAILED DESCRIPTION

A tool according to some embodiments is provided to enable extraction of events associated with business processes from various sources for the purpose of enabling reporting about such business processes. Examples of business processes include invoicing, shipping goods, paying bills, approving expenses or purchases, and so forth. To reduce the complexity and detail associated with the reporting of business processes, users of the tool can provide abstract process definitions for identifying a high level, simplified (or otherwise modified) version of the business process that is of interest for the purpose of reporting, as the high-level, simplified (or otherwise modified) version focuses on interesting (or business relevant) aspects, and abstracts out unnecessary details, of the actual business process. Also, process mapping definitions are provided to map events (which have been extracted from various systems that support the execution of the various steps of the actual process) to the steps of interest in the abstract business processes. An “abstract” business process refers to the business process with unnecessary details left out. Using the process mapping definitions and abstract process definitions, the tool according to some embodiments is able to group events into sets of related events, which sets of related events are then mapped to steps of the abstract business process. The sets of related events are also used to produce output information according to a predefined format (e.g., tables), which is then used to provide business process reporting. The output information is stored in a data warehouse for subsequent retrieval and/or manipulation. More generally, the output information is stored in a repository (which can be any storage location).

Although reference is made to business processes, it is noted that techniques according to some embodiments can be applied to other types of processes associated with other types of organizations, such as educational organizations, government agencies, and so forth. A process can be considered a set of one or more linked steps that collectively realize an objective (e.g., a business objective, an educational objective, a government objective, etc.) or a policy goal. An event represents an activity associated with a start or completion of a step in a process. The event also specifies one or more correlation parameters to correlate the event to other events. A data warehouse refers to a collection of one or more databases, implemented on one or more nodes, for storing information.

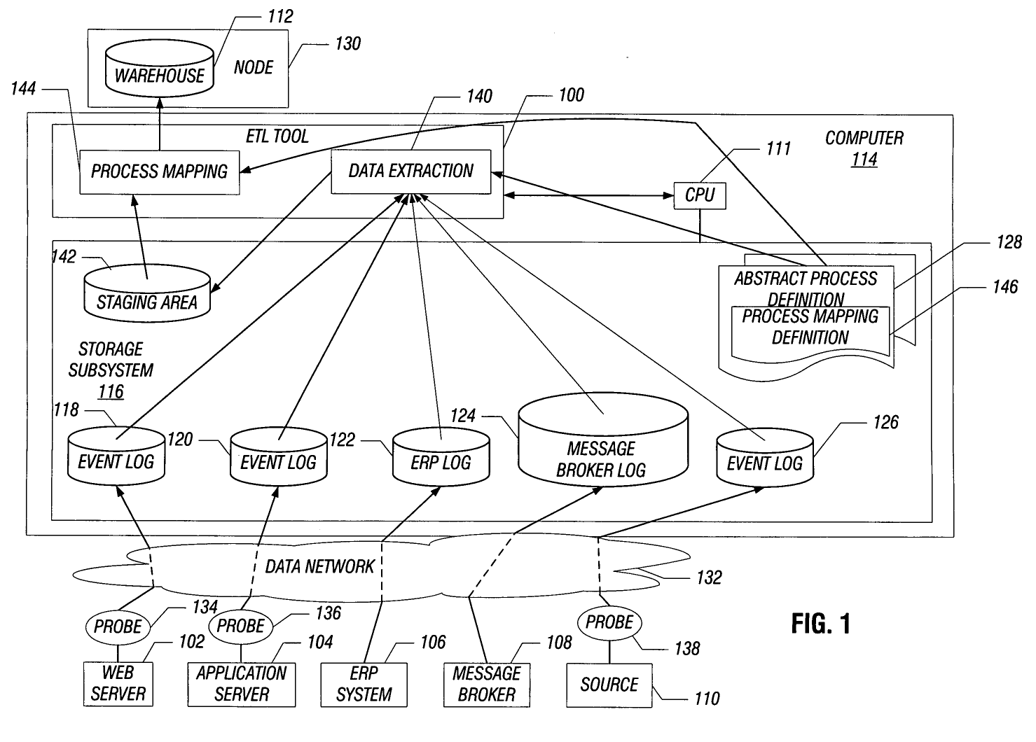

FIG. 1 illustrates an example arrangement that includes a tool 100 according to some embodiments. The tool 100 is referred to as an ETL (extract, transformation, and load) tool 100 for extracting events from various sources (e.g., 102, 104, 106, 108, and 110); identifying a subset of the events associated with process steps of interest for inclusion into execution sets of events; generating output information (e.g., tables) according to the execution sets; and loading the output information into a data warehouse 112 or some other storage location.

In some embodiments, the ETL 100 is a software tool executable on a central processing unit (CPU) (or multiple CPUs) 111 that are part of a computer 114. The computer 114 also includes a storage subsystem 116 that contains various files (e.g., databases, tables, etc.) for storing information usable by the ETL tool 100. In FIG. 1, the various files include logs (118, 120, 122, 124, and 126) containing log information. The files in the storage subsystem 116 also include abstract process definitions 128 for defining steps of respective processes that are of interest for purposes of reporting.

Although the logs 118-126 are depicted as being stored in a storage subsystem 116 in the same computer 114 as the ETL tool 100, it is noted that one or more of the logs 118-128 can be located at a remote storage location on a node that is separate and distinct from the computer 114. In FIG. 1, the data warehouse 112 is depicted as being located on a node 130 that is separate from the computer 114. The node 130 is coupled to the computer 114 over a network. Note, however, that in other implementations, the data warehouse 112 can be stored in the storage subsystem 116 of the computer 114.

The various sources of events that are coupled to the computer 114 over a data network 132 include, as examples, a web server 102, an application server 104, an enterprise resource planning (ERP) system 106, a message broker 108, and one of more other sources 110. In other implementations, many other types of sources can be provided. Examples of the data network 132 include a local area network (LAN), a wide area network (WAN), or the Internet.

Some of the sources 102-110 can be workflow engines that execute corresponding business processes. Sources may themselves provide an event log (such as from a workflow engine), or otherwise probes (e.g., probes 134, 136, and 138) may have to be provided to monitor information exchange of the source system and collect event information. For example, probes (in the form of a software application, for example) can be implemented as part of the ERP system 106 and message broker 108 to collect event information. The collected event information can be provided to respective logs 122 and 124.

The events collected into the logs 118-126 can represent invocation of application programs, invocation of software methods (e.g., such as Java routines), communication of data, action by a user, and so forth. Each event can be associated with one or more parameters. For example, an approval message may have the approver's name and the approval result as parameters. As discussed further below, the one or more parameters are used to correlate events to each other.

Each of the abstract process definitions 128 provides an identification of steps of a process that are of interest for reporting. Normally, to reduce the complexity and detail of information in reporting about execution of a process, the respective abstract process definition includes just a relatively small number of steps.

In FIG. 1, multiple abstract process definitions 128 are provided, one for each corresponding process. Alternatively, a single abstract process definition can be provided for multiple processes, or, many abstract process definitions can be defined for one actual process.

A data extraction module 140 in the ETL tool 100 extracts events from the logs 118-126, and provides the extracted events to an events staging area 142. The data extraction module 140 extracts just events that are of interest according to the abstract process definitions 128. The data extraction module 140 uses process mapping definitions 146 to identify events corresponding to subsets of steps that are of interest. Note that the logs 118-126 can contain events for all steps of each execution of a process. To reduce complexity and enhance efficiency (in terms of storage and processing), not all of the events are extracted by the data extraction module 140 from the logs.

The events staging area 142 is a temporary storage location, which can be part of the storage subsystem 116, for temporarily storing information pertaining to extracted events. A process mapping module 144 in the ETL tool 100 then retrieves information about the events from the staging area 142 and scans for events of interest for each particular execution of a process (the events that are mapped to steps identified by the abstract process definition). The process mapping module 144 uses process mapping definitions 146 that map events to corresponding process steps.

In the embodiment depicted in FIG. 1, the process mapping definitions 146 are part of corresponding abstract process definitions 128; alternatively, the definitions 128 and 146 can be separate.

The process mapping module 144 maps the events into respective execution sets, where each execution set contains events that are part of a particular execution of a process. The events in each execution set are related to each other according to one or more correlation parameters of the events and correlation conditions specified for those correlation parameters. The parameters and conditions are defined by the process mapping definitions 146. In some embodiments, events are correlated in a pairwise fashion. In other words, each given event is correlated to one other event based on some condition specified on a parameter (or plural parameters) of the events in the pair. Each pair of correlated events can then be correlated to one or more other pairs of events such that a chain of events can be defined for a particular execution of a process.

For example, if a given execution of a process has events A, B, C, D, E, and so forth, then the following pairs of correlated events may be specified {A, B}, {B, D}, {D, C}, {C, E}, and so forth. Note that pair {A, B} is correlated to pair {B, D} by event B, pair {B, D} is correlated to pair {D, C} by event D, and so forth. This chain of pairs of events allows all events for a particular execution set (associated with a particular execution of a process) to be identified.

In alternative embodiments, other techniques for correlating events can be utilized.

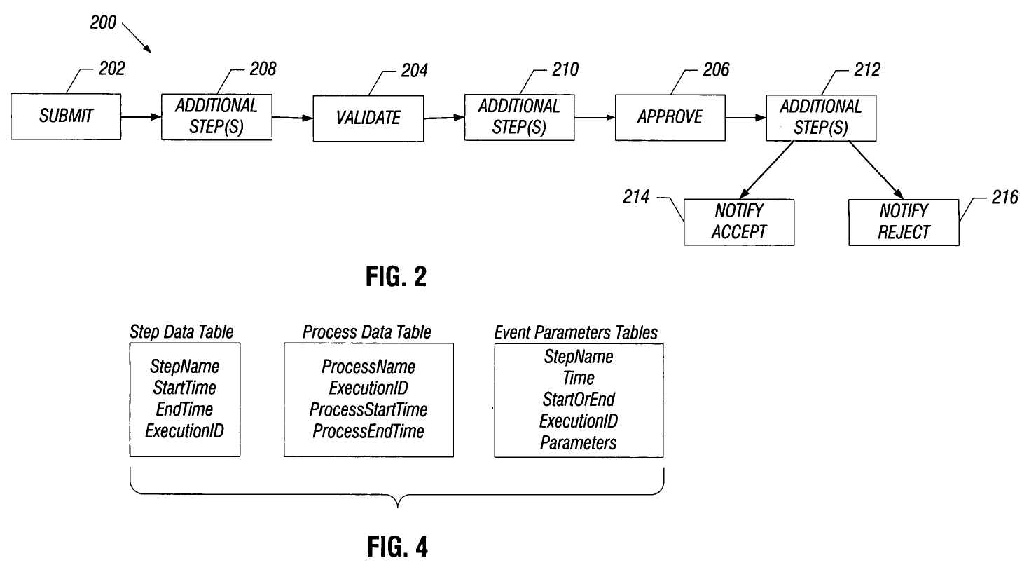

The abstract process definition includes the specification of which events correspond to the start or completion of each process step. The abstract process definition also specifies correlation parameters (and correlation conditions) of the corresponding events. For purposes of example, a business process can be an approval process (such as for approving a request for an expense, a purchase request, and so forth). FIG. 2 shows an example approval business process 200, which includes a submit step 202 (to submit a request for a corresponding item, such as an expense, a purchase, etc.), a validate step 204 (for validating the requestor or the request), and an approve step 206 (for approving or denying the request). Note that additional steps 208, 210, and 212 would also typically be part of the approval process 200 of FIG. 2. Other steps of the approval business process 200 include a notify accept step 214 (to notify the requestor that the request has been accepted) and a notify reject step 216 (to notify the requestor that the request has been rejected.

The abstract process definition 128 for the approval process can identify a subset (less than all) of the steps that are of interest for purposes of reporting, or the abstract process definition 128 can identify steps that correspond to a collection of steps in a lower level process. As an example, the abstract process definition 128 for the approval process 200 can identify the submit step 202, validate step 204, and approve step 206 as being the steps of interest for reporting. By omitting the remaining steps (208, 210, 212, 214, 216) in the abstract process definition for the approval process, information associated with such other steps are not extracted for the purpose of developing a report regarding execution of the approval process.

Events that correspond to the start and/or completion of a step can be specified by the process mapping definition 146. For example, for the approval process 200 of FIG. 1, the start event for the submit step 202 is when a user logs into a portal (such as a website at the web server 102 in FIG. 1) and selects an approval work item from the work queue associated with the user. In one example implementation, the selection of the approval work item can be represented as a workItemSelection event that is captured by the probe 136 associated with the application server 104 (FIG. 1). The end of the submit step 202 is represented by a user submitting a web form (that has been filled out), following which a message is sent to a web service with the submission information (contained in the web form). The submission of the web form and sending of message to a web service is an event (which can be represented as an approval event) that can be monitored and logged by the message broker 108 (FIG. 1).

In addition to specifying events (such as the workItemSelection and approval events above), the definer of the abstract process definition also specifies correlation parameters and conditions that allow events that belong to the same execution of a process to be matched (correlated). For example, assume the workItemSelection event has an example parameter approvalRequestID, and the approval event also has the same parameter. This parameter can then be used for matching the events by using the following correlation condition: workItemSelection.approvalRequestID=approval.approvalRequestID. The events can have other parameters.

In the example of FIG. 2, other events are also defined (in the respective process mapping definition 146) for the validate steps 204 and approve steps 206, which other events can be correlated by parameter(s) associated with such other events and by correlation conditions specified for the parameter(s).

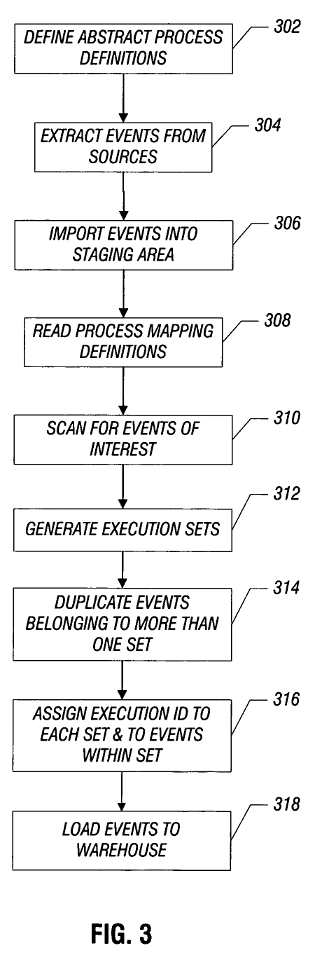

FIG. 3 depicts a procedure performed by the ETL tool 100 according to an embodiment. Note that the procedure of FIG. 3 can be performed for one or plural executions (instances) of processes designated by a user as being of interest for logging. Alternatively, the procedure of FIG. 3 can be performed for all executions of processes.

Initially, abstract process definitions 128 (and associated process mapping definitions 146) are defined (at 302) and received and stored by the ETL tool 100 in the computer 114 (FIG. 1). The definition of the definitions 128 and 146 is performed by an administrator(s) or operator(s) of the ETL tool 100.

Next, events are extracted (at 304) from the various sources by the data extraction module 140 (FIG. 1). The abstract process definitions 128 and process mapping definitions 146 are used by the data extraction module 140 to extract just the events specified as being of interest for particular executions of processes. The extracted events are imported (at 306) by the data extraction module 140 into the events staging area 142. The process mapping module 144 next reads (at 308) the process mapping definitions 146. The process mapping module 144 uses the process mapping definitions 146 to scan for events of interest (at 310), where events of interest include events corresponding to the steps of the process identified by the corresponding abstract process definition for the particular process execution(s) under consideration.

Using the process mapping definitions 146, all execution sets E of events are generated (at 312), where each execution set E contains events for a particular instance (execution) of a process. If only one execution of one process is being evaluated by the tool 100, then just one execution set E would be generated. Basically, each execution set E contains all events for a particular instance (execution) of a process. More precisely, to generate a particular execution set E, for each event e in the set, there is another event eᵢ so that a correlation condition between these two events is defined and is true for the pair {e, eᵢ}. As noted above, pairs of events {eⱼ, eₖ} are correlated to each other such that a chain of events can be derived for inclusion in the execution set E until there is no event in the staging area 142 that is not in the particular execution set E and that is correlated to an event in E.

In some cases, an event may belong to multiple execution sets. Events that belong to more than one execution set are duplicated (or copied multiple times as appropriate) (at 314). Each execution set is assigned (at 316) an execution ID (which is unique to each execution set). Also, all events within a particular execution set are marked (at 316) with the same execution ID. If an event is copied multiple times because the event exists in multiple execution sets, the multiple copies of the events will have different execution IDs.

Next, the events are loaded (at 318) into the data warehouse 112. The events are loaded as output information in a format that is amenable to process reporting. As part of the loading process, the output information is converted from the execution sets. In one example embodiment, the format of the output information is in the form of various tables, such as the tables depicted in FIG. 4. Note, however, in other embodiments, other formats can be used when loading the events into the data warehouse. The desired formats according to some embodiments includes formats (in the form of tables or other data structures) in which the events are organized according to processes and steps of the processes, so that a user can quickly and easily determine various characteristics associated with the particular execution of the process. As part of loading the events, the information about mapping between events and steps is used to determine step start and completion time, based on event occurrence timestamps. Effectively, the output information constitutes information or data relating to an execution (or instance) of an abstract process (in other words, a simplified or otherwise modified version of an actual process), where the output information is produced according to the execution sets.

In the example embodiment of FIG. 4, the following output tables (for loading into the data warehouse 112) are associated with each execution of a process: a step data table 400, a process data table 402, and event parameters tables 404. The step data table 400 according to an example includes the following attributes: StepName (identifying the name of the particular step); StartTime (indicating the time corresponding to the start event of the step); EndTime (indicating the end time corresponding to the time of the end event of the step); and ExecutionID (which is the execution ID assigned at 316 in FIG. 3). The StepName, StartTime, EndTime, and ExecutionID attributes can be arranged in columns of the step data table 400, with each row of the step data table 400 corresponding to a respective step of the process. In other words, if the process contains five steps, then there will be five rows in the step data table 400, with each row containing values for the attributes StepName, StartTime, EndTime, and ExecutionID.

The process data table 402 according to the example of FIG. 4 includes the following attributes: ProcessName (the name of the process, which may have been assigned by the administrator); ExecutionID; ProcessStartTime (which corresponds to the minimum time among all the times of events in the execution set E having the value executionID); ProcessEndTime (which corresponds to the maximum time among all times of the events in the execution set E).

There may be multiple event parameters tables 404 corresponding to different event types. Different types of events may have different parameters (and different numbers of parameters) that map to different data structures. For example, an approval request event may have the following parameters: requester name, expense item, and approval amount. The attributes of the event parameters table 404 include: StepName (the name of the step that the particular event is associated with); Time (which indicates the time of the event); StartOrEnd (to indicate whether the event is the start event or end event of a step); ExecutionID; and one or more Parameters (which are the parameters of the event).

Note that the execution ID value is what correlates the step data table 400, process data table 402, and event parameters tables 404. Moreover, the StepName attribute is used to correlate entries of the step data table 400 and the entries of one or more event parameters tables 404, and to denote that the step data refers to the value of the parameter after the step has been completed.

The data in the tables stored in the data warehouse 112 can be subsequently retrieved and presented as output to users. Alternatively, the tables can be manipulated to provide an output in a different form, such as in tables of different forms, charts, bar graphs, and so forth.

Instructions of software described above (including the ETL tool 100 and other software in FIG. 1) are loaded for execution on a processor (e.g., CPU(s) 111). The processor includes microprocessors, microcontrollers, processor modules or subsystems (including one or more microprocessors or microcontrollers), or other control or computing devices.

Data and instructions (of the software) are stored in respective storage devices (such as storage subsystem 116 in FIG. 1), which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method executable in a computer, comprising:
receiving events from at least one source;
providing an abstract definition of a process to provide a modified version of the process;
in accordance with a mapping definition, identifying events from the received events that correspond to the modified version of the process; and
storing data relating to execution of the process into a repository, wherein the stored data is produced from the identified events.

2. The method of claim 1, further comprising:
performing pairwise correlation of the events associated with the process; and
determining an execution set corresponding to the execution of the process, wherein the execution set includes correlated events according to the pairwise correlation.

3. The method of claim 1, wherein the process has plural steps, and wherein the abstract definition of the process identifies a subset of the plural steps to provide the modified version of the process, the method further comprising storing the mapping definition, wherein the mapping definition maps events to corresponding steps in the modified version of the process.

4. The method of claim 3, wherein storing the mapping definition comprises storing the mapping definition as part of the abstract definition.

5. The method of claim 1, wherein providing the abstract definition of the process comprises providing the abstract definition of a business process that is selected from the group consisting of invoicing, shipping goods, paying bills, approving expenses, and approving purchases.

6. The method of claim 1, wherein receiving the events comprises receiving the events from plural sources.

7. The method of claim 6, further comprising receiving the events into plural respective logs, wherein the logs contain events for plural steps of the process.

8. The method of claim 7, further comprising extracting, from the logs, events for a subset of the plural steps identified by the abstract definition.

9. The method of claim 1, wherein the process has plural steps, and wherein the abstract definition of the process identifies a subset of the plural steps to provide the modified version of the process, the method further comprising:
correlating events of the subset of steps using the mapping definition; and
loading the correlated events into an execution set.

10. The method of claim 9, wherein the identified events comprise the correlated events, the method further comprising converting the correlated events in the execution set into data structures that organize the correlated events according to steps of the process.

11. The method of claim 10, further comprising loading the data structures into a data warehouse, the repository comprising the data warehouse.

12. The method of claim 1, wherein receiving the events comprises receiving the events from one of a workflow engine included in the at least one source that provides an event log and a probe that monitors an information exchange of the at least one source.

13. The method of claim 1, wherein providing the abstract definition of the process comprises providing the abstract definition having business relevant process steps abstracted from an actual process.

14. Instructions in a computer-usable storage medium that when executed cause a system to:
receive events from at least one source;
provide an abstract definition of a process having plural steps, wherein the abstract definition of the process identifies a subset of the plural steps;
in accordance with a mapping definition, identify events from the received events that correspond to the subset of steps identified by the abstract definition; and
provide the identified events in a form to enable reporting regarding the process.

15. The instructions of claim 14, wherein the mapping definition correlates events of the process by defining conditions on one or more parameters of the events.

16. The instructions of claim 15, which when executed cause the system to further:
correlate the events of the subset of the steps of the process using the mapping definition; and
load the correlated events into an execution set, the identified events comprising the correlated events.

17. The instructions of claim 15, wherein providing the identified events comprises providing the identified events for a first execution of the process, the instructions when executed causing the system to further identify events for another execution of the process.

18. A method comprising:
receiving, over a network from plural sources, events corresponding to plural steps of a business process instance;
extracting, from the received events, a subset of events corresponding to a subset of the plural steps of the business process instance, wherein the extracting is based on an abstract definition that identifies the subset of steps;
correlating the extracted events; and
generating an output according to the correlated events to enable reporting of the business process instance.

19. The method of claim 18, further comprising loading the correlated events into an execution set corresponding to the business process instance, wherein generating the output is based on the execution set.

20. The method of claim 18, wherein generating the output comprises generating output tables that are related to each other using an identifier of the business process instance.
